(19) United States
(12) Patent Application Publication
(10) Pub. No.: US 2014/0367506 A1
(43) Pub. Date: Dec. 18, 2014

(54) Snap on Spool Winding Device, Capture Device, System and Method

(71) Applicant: Robin Hancock, Elkhorn, WI (US)

(72) Inventor: Robin Hancock, Elkhorn, WI (US)

(21) Appl. No.: 14/304,361

(22) Filed: Jun. 13, 2014

Related U.S. Application Data
(60) Provisional application No. 61/834,651, filed on Jun. 13, 2013.

(51) Int. Cl. A01K 89/00; A01K 89/08; A01K 97/01

(52) U.S. Cl. CPC A01K 89/006; A01K 97/01; A01K 89/08
USPC 242/283

(57) ABSTRACT

A spool winding device for snap fit on a spool is disclosed. The device may include a planar body, at least one aperture, and an upstanding knob. The invention further provides a tip-up capture device for use during storage and transportation of an ice fishing tip-up. A stowing system for retaining an ice fishing tip-up in stored position during transportation and storage, including the snap-on spool winding device and capture device and method is provided.

### RELATED APPLICATIONS

This application claims the benefit of co-pending U.S. Provisional Patent Application Ser. No. 61/834,651, filed on 13 Jun. 2013.

### BACKGROUND OF THE INVENTION

Typical ice-fishing tip-ups, particularly those sold under the BEAVER DAM trademark, operate to catch fish through a hole in the ice and to signal the fisher that a catch has been made. When the fish has been retrieved, or when the fisher has completed fishing, the line must be rewound onto the spool. Rewinding the line is typically done by hand by grasping the line and re-rolling it onto a spool. This task is clumsy while wearing gloves, so the fisher will typically remove gloves or other hand covering to complete the task. This can be challenging in the cold weather conditions associated with ice fishing. Further, elongate objects, such as ice fishing tip-ups, may easily become entangled during transportation and storage. Thus, a device for assisting the user in rewinding a line in cold conditions and a stowing tool is desired.

### SUMMARY OF THE INVENTION

The present invention is directed to ice fishing tools, and specifically to a snap-on spool winding device and a tip-up capture device and system for use with an ice-fishing tip-up, and method of use.

The present invention provides a snap-on spool winding device, and method of using, which is easy to use in various settings, including under ice fishing conditions. A spool winding device according to the present invention may assist in winding fish line onto the spool of an ice fishing device, such as a tip-up. The spool winding device may further be used in other environments in which a spool to be wound lacks a winder. The snap-on spool winding device may include a planar body having at least one aperture, and an upstanding knob. The planar body includes a web portion supported by a circumferential edge portion.

The present invention further provides a capture device for use during storage and transportation of elongate items such as an ice fishing tip-up. The capture device may preferably include a clip portion for securing the device to an elongate item, such as a tip-up, at least one upstanding mounting element, and at least one transverse rib member.

The present invention may further provide a stowing system for retaining an elongate item, such as an ice fishing tip-up, in stowed position during transportation and storage. A stowing system may include a snap-on spool winding device and a capture device.

### BRIEF DESCRIPTION OF THE DRAWINGS

FIG. 1 is a perspective view showing a prior art method of rewinding line onto a spool.

FIG. 2 is a front perspective view of a snap-on spool winder according to the present invention.

FIG. 3 is a rear perspective view of a snap-on spool winder according to the present invention.

FIG. 4 is a cross sectional view of the snap-on spool winder shown in FIG. 2, taken along lines 4-4 thereof, and showing a retaining edge.

FIG. 5 is a fragmentary view of tip-up and showing installation of a snap-on spool winder according to the present invention.

FIG. 6 is a view similar to that of FIG. 5, but showing the snap-on spool winder installed and in position for use.

FIG. 7 is a view similar to that of FIGS. 5 and 6, but showing the snap-on spool winder installed and in use.

FIG. 8 is a perspective view of a prior art, Beaver Dam type ice fishing tip-up in operational position.

FIG. 9 is a perspective view of a capture device according to the present invention.

FIG. 10 is a view similar to that of FIG. 8, but showing the snap-on spool winder and capture device of the present invention installed and in position for use.

FIG. 11 is a view similar to that of FIG. 10, but showing the spool with snap-on spool winder moving into storage position.

FIG. 12 is a fragmentary bottom view of a tip-up with the snap-on spool winder positioned on the spool and the handle moving into the mounting structure on the capture device.

FIG. 13 is a view similar to that of FIG. 12 but showing a tip-up with the snap-on spool winder positioned on the spool and the winder in stowed position on the capture device.

FIG. 14 is a view similar to that of FIGS. 12 and 13, but showing a portion of the line and hook stowed on the capture device.

FIG. 15 is a perspective view of the tip-up illustrated in FIG. 10 but in stowed position with the stowing system securing the various components for transportation.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

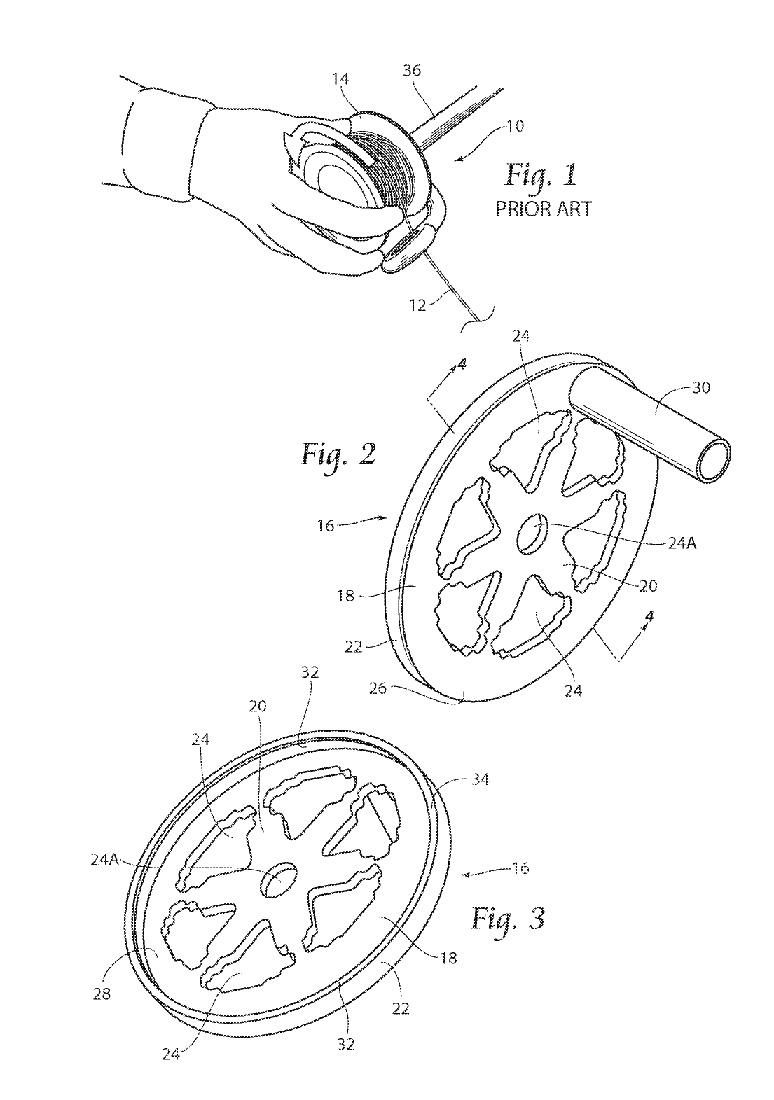

Ice fishing tip-up devices are commonly used to catch fish during ice fishing, and to signal the user that a fish has been caught by way of a signal device, such as a flag. When the user has completed fishing for the day, many commonly used tip-ups require the user to rewind the fishing line onto the spool by hand, by grasping the line and re-rolling it onto a spool. This technique can be clumsy and impeded by the cold, use of gloves and the formation of ice on the line. FIGS. 1 and 10 illustrate a typical ice fishing tip-up 10 with FIG. 1 showing a user rewinding the line 12 onto a spool 14 by hand. Occasionally, an integrally formed spool and winder has been employed (not shown). While these techniques have been used for years, the present invention provides a detachable, easily installable snap-on spool winding device 16 for use with tip-ups of the type illustrated in FIG. 1. The spool winding device 16 may also be used as part of a stowing system, as will be later discussed.

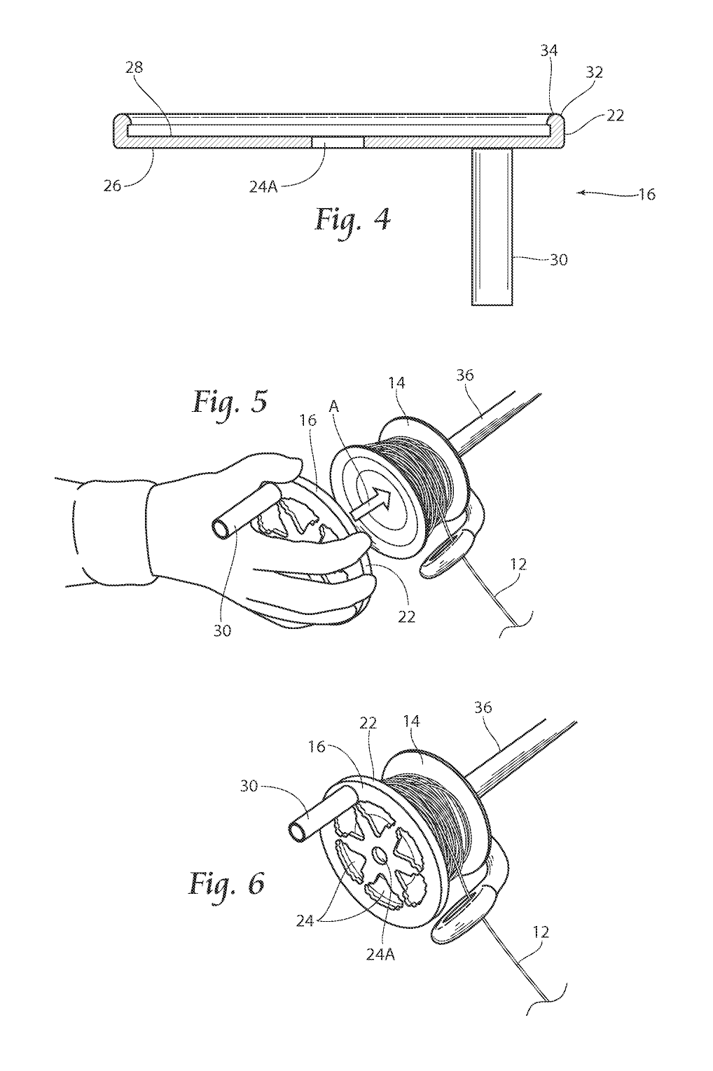

With particular attention to FIGS. 3-4, a snap-on spool winding device 16 according to the present invention may be seen. As illustrated, the winding device 16 includes a planar body 18 having a web 20 supported by a circumferential edge 22. The web 20 includes a plurality of apertures 24 therein, a front planar surface 26, and a back planar surface 28. The front surface 26 preferably includes an upstanding handle member 30 for ease of grasping and manipulating the device during use. As seen, the apertures 24 may include a center aperture 24A and an array of circumferential apertures 24.

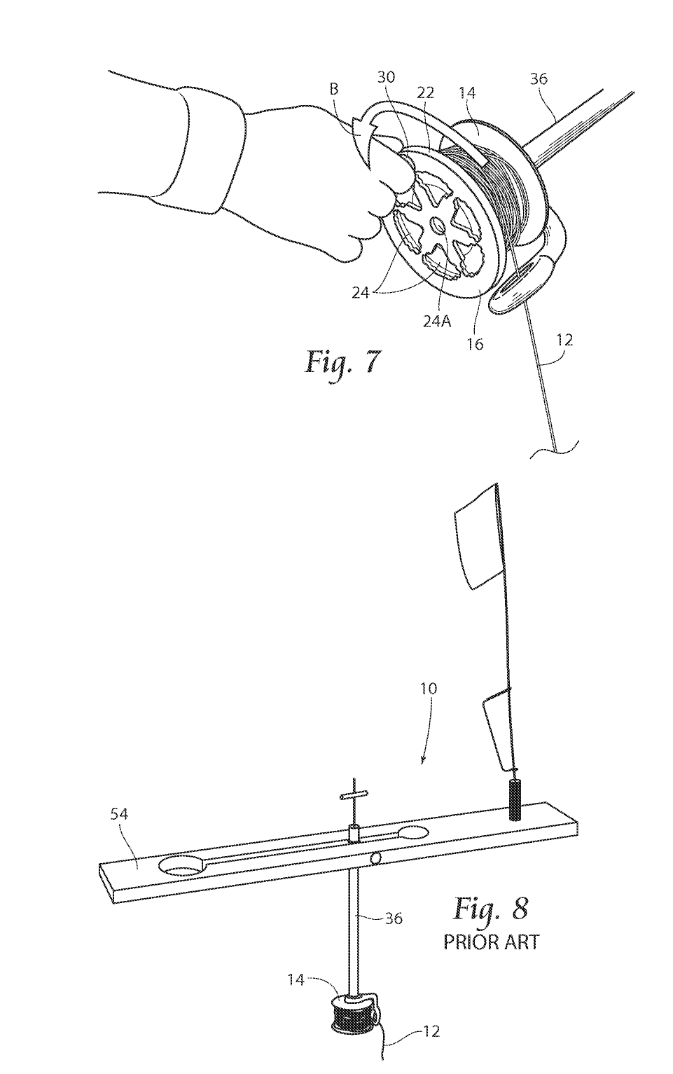

With specific reference to FIGS. 3 and 4, it may be seen that the back planar surface 28 of the device 16 may include an upstanding edge portion 32. The portion 32 preferably extends laterally from the edge 22 and perpendicular to the back planar surface 28 to provide a flange or rim member 34. The rim member 34 is adapted for snap-on inference fit with a spool 14 of an ice fishing tip-up 10 or other spool in need of rewinding. The winding device 16 is easily installed on a spool, such as an ice fishing spool 14, as is depicted in FIG. 5. As is viewed in FIG. 5, the user merely grasps the device 16 with the back surface 28 facing the spool 14, moves the device 16 in the direction of arrow A, and snaps the rim 34 around the spool 14. If the spool 14 is provided with a rod 36 that extends through the spool 14, the center aperture 24A may be positioned over the rod 36, to aid in centering the device 16 on the spool 14. Once the snap-on spool winding device 16 is positioned on a spool 14, as is shown in FIG. 6, the handle member 30 may be grasped and rotated in the direction of arrow B (see FIG. 7), to thereby wind the line, such as fishing line 12, onto the spool 14. The array of circumferential apertures 24 provide water evacuation if the device 16 is immersed. While the spool winding device 16 is shown and described in conjunction with an ice fishing tip-up spool 14, it is to be understood that the device 16 may be utilized to aid in winding other spools (not shown).

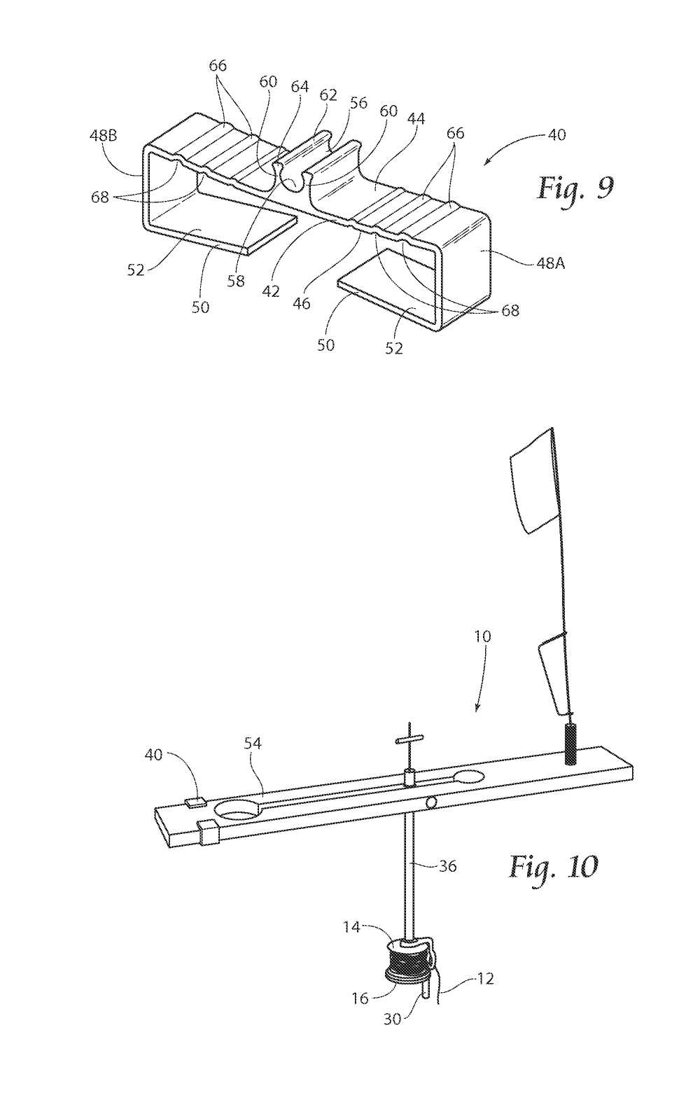

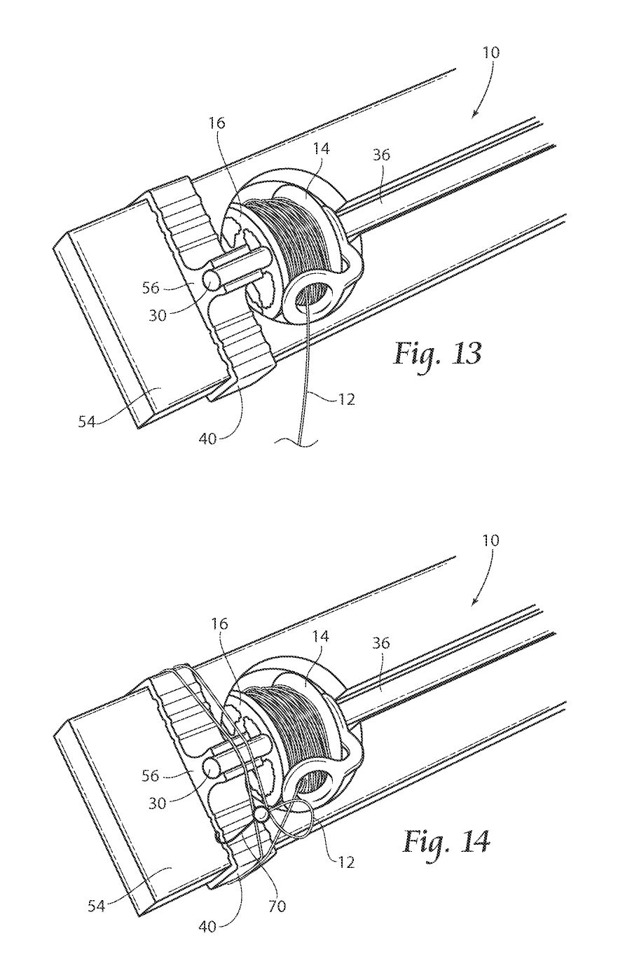

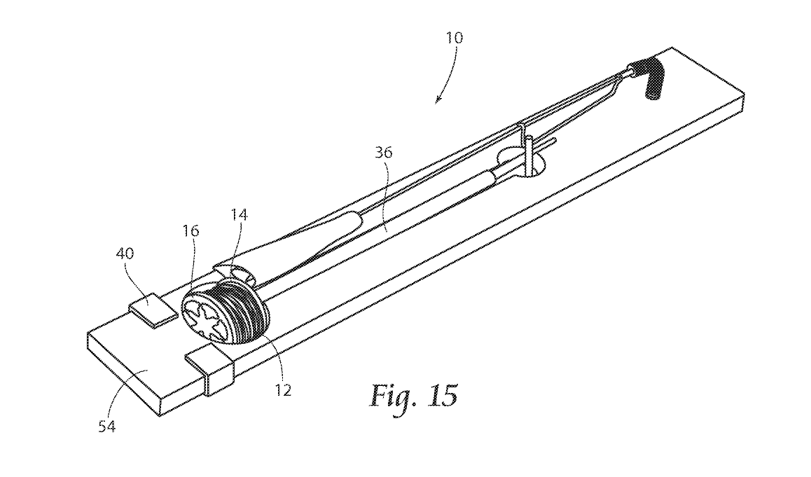

With attention now to FIGS. 9-15, it may be seen that the present invention may be further directed to a tip up capture device 40, method and stowing system. With specific reference to FIG. 9, the capture device 40 may be seen to include a base 42 having a top surface 44, a bottom surface 46, and opposed arm members 48A, 48B. Each of the arms 48A, 48B preferably includes a distal end 50 forming a clip member 52. Each clip member 52 is preferably sized to engine a frame, such as tip-up frame 54. The top surface 44 of the base 42 further preferably includes an upstanding, laterally extending mounting structure 56. The mounting structure 56 includes an arcuate portion 58 terminating in spaced apart arm members 60. The arm members 60 may each further include a distal end 62 having an expanded portion 64 for snap fit of a handle 30 therein. The dimension of the arcuate portion 58, and spacing of the arm members 60, is suitable for supporting a handle 30 of the winding device 16, as will be discussed.

As is seen in FIG. 9, the top surface 44 of the capture device 40 may further include a plurality of laterally spaced ridges 66. The ridges 66 may vary in height and correspond to valleys 68 located on the bottom surface 46 of the capture device 40. The ridges 66 and valleys 68 cooperate to provide a hook 70 holding area (see FIG. 14), with the various heights and spacing allowing the user to store hooks 70 of varying sizes.

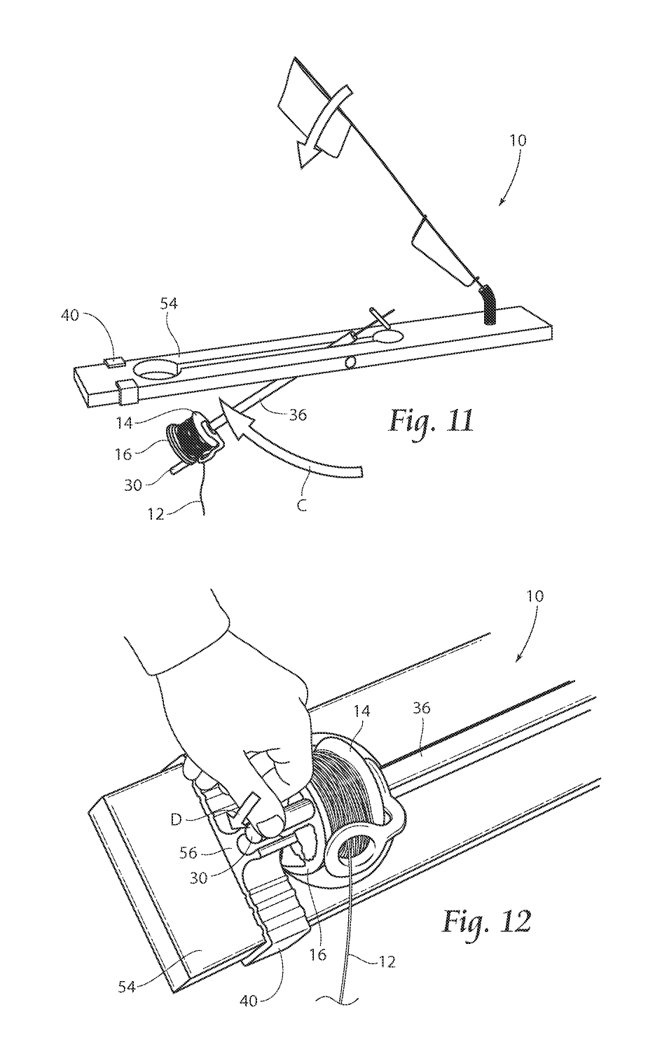

FIGS. 10-15 illustrate the winding device 16 and capture device 40 in cooperating use as a stowing system. As seen, the capture device 40 is installed on a tip-up frame 54, with the capture device top surface 44 orientated to face a spool 14 with the winding device 16 installed on the spool 14 as is described above. When storage of the tip-up 10 is desired, the user moves the spool 14 in the direction of arrow C (see FIG. 11) and toward the capture device 40. As is seen in FIG. 12, the user may then snap the handle member 30 of the winding device 16 into the mounting structure 56 in the direction of arrow D. Excess line 12 may be wrapped around the tip-up frame 54 and any attached hooks 70 inserted in the valleys 68 and ridges 66 for transportation.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. A spool winding device including:
a planar body, said body including a web supported by a circumferential edge;
said web including a front planar surface and a back planar surface, said front planar surface including an upstanding handle member; and
said back planar surface including an upstanding flange member located on said circumferential edge.

2. The spool winding device of claim 1 wherein said web further includes a plurality of apertures therein.

3. A capture device including a base, said base having a top surface, a bottom surface, and opposed arms members, wherein each arm member includes a distal end forming a clip member.

4. The capture device of claim 3 wherein said top surface further includes an upstanding, laterally extending mounting structure.

5. The capture device of claim 4 wherein said mounting structure includes an arcuate portion terminating in spaced apart mounting arm members.

6. The capture device of claim 5 wherein each of said mounting arm members includes a distal end having an expanded portion.

7. A stowing system including:
a capture device, said capture device including a base, said base having a top surface, a bottom surface, wherein said top surface includes an upstanding laterally extending mounting structure; and
a spool winding device, said spool winding device including a planar body, said body including a web supported by a circumferential edge, said web including a front planar surface and a back planar surface, said front planar surface including an upstanding handle member, wherein said handle member is engagable in said mounting structure.

8. The system of claim 7 wherein said mounting structure said includes an arcuate portion terminating in spaced apart mounting arm members.

9. The system of claim 8 wherein each of said mounting arm members includes a distal end having an expanded portion.

10. The system of claim 7 wherein said base further includes opposed arms members, each arm member having a distal end forming a clip member.

11. The system of claim 7 wherein said back planar surface further includes an upstanding flange member located on said circumferential edge.

12. The system of claim 7 wherein said web further includes a plurality of apertures therein.
